(19) United States
(12) Patent Application Publication
(10) Pub. No.: US 2011/0289821 A1
(43) Pub. Date: Dec. 1, 2011

(54) Humane racoon restraint

(76) Inventor: Gary D. Bonnot, Bonnots Mill, MO (US)

(21) Appl. No.: 12/802,046

(22) Filed: May 27, 2010

(51) Int. Cl. A01M 23/34; A01M 23/00

(52) U.S. Cl. 43/86; 43/85

(57) ABSTRACT

A raccoon foot-restraining trap has a bait trigger that is sized and shaped, for example in the form of a ring, to snag the foot of the raccoon as the foot is pushed into the trap in an effort to obtain bait. The bait cannot be touched by the raccoon without also activating the trap.

### BACKGROUND

1. Technical Field

The invention relates to a trap for humanely restraining the foot of an animal without causing undue pain or distress. More particularly, the invention concerns an improved bait trigger for a raccoon trap. An actuator of the trigger snags the underside of a raccoon's paw and claws as the raccoon pulls on the bait; thereby activating a foot restraint mechanism.

2. Background Information

It is known that raccoons may be trapped by clamping their front foot within a restraint cuff when the raccoon reaches into the cuff in an effort to retrieve bait. In particular, one such trap known as the Lil' Grizz Get'rz has been commercially available for about a decade and has been used to humanely trap and restrain raccoons. This particularly effective raccoon restraint is disclosed and claimed in U.S. Pat. No. 6,658,787.

While the noted Lil' Grizz Get'rz trap is very effective, a lever bait trigger that is used to activate this trap is sometimes manipulated by raccoons in a manner that allows the raccoons to take the bait and escape without triggering the restraint.

Accordingly, it would be advantageous to provide the Lil' Grizz Get'rz or other foot restraint traps with an improved bait trigger that will reliably activate the restraint of the trap and prevent a raccoon from stealing bait.

It would also be advantageous to provide such a bait trigger with an improved actuator that is shaped to engage and snag the underside of the paw and claws of a raccoon's front foot; thereby forcing the raccoon to activate the trap when it pulls on the actuator in an attempt to obtain the bait.

It would also be advantageous to provide such an improved actuator that is shaped in the form of a ring in order to optimize snagging contact with the underside of the paw and claws of a raccoon's front foot.

### BRIEF SUMMARY

The invention concerns the use of an improved bait trigger for foot restraint traps. An actuator of the bait trigger is sized, positioned and shaped so that it is not possible for a dexterous animal such as a raccoon to reach around the actuator and pull bait from the trap, without activating the trap. In particular, the actuator for the trap may be ring-shaped to engage and snag the underside of the paw and claws of a raccoon's front foot. An actuator of the noted type will increase the reliability of any trap that restrains the foot of an animal such as a raccoon.

### BRIEF DESCRIPTION OF THE DRAWINGS

FIG. 1 illustrates a perspective view of a known trap that is used to restrain the front foot of a raccoon in a humane fashion.

FIG. 2 is a bottom elevation view of some of the components of the humane foot restraint of FIG. 1.

FIG. 3 is a top elevation view of some of the components of the humane foot restraint of FIG. 1.

FIG. 4 is a bottom elevation view of a raccoon's paw.

FIG. 5 is a top elevation view of an improved actuator for a bait trigger.

FIG. 6 is a cross-sectional side elevation view of some of the components of the trap of FIG. 1 with an improved actuator for a bait trigger.

FIG. 7 is a top elevation view of the improved actuator of FIG. 5 as it is initially formed in manufacturing.

FIG. 8 is a side elevation view of the improved actuator of FIG. 7 after it has been twisted in manufacturing to orient the actuator at its final operational position with respect to a lever portion of the bait trigger.

FIG. 9 is a partial cross-sectional side elevation view of the bottom portion of the trap of FIG. 6, showing bait engaged and captured by the improved actuator of FIGS. 5-8.

FIG. 10 illustrates a partial cross-sectional side elevation view of the bottom portion of the trap of FIG. 6, showing a larger portion of bait trapped by the improved actuator of FIGS. 5-8.

FIG. 11 is a partial cross-sectional side elevation view of the trap of FIG. 6 anchored in the ground and set.

FIG. 12 is a cross-sectional side elevation view of the trap of FIG. 6 after it has been set and anchored in the ground, with the end of a raccoon's front foot engaging the improved actuator and triggering the trap.

FIG. 13 is a cross-sectional side elevation view of the trap of FIG. 6 oriented upside down.

FIGS. 14a-c illustrate various diagrammatic top elevation views of alternative actuators and housings for a foot restraint trap.

FIGS. 15a-d illustrate various top elevation views of alternative ring-shaped actuators for a foot restraint trap.

### DETAILED DESCRIPTION OF THE DRAWINGS AND THE PRESENTLY PREFERRED EMBODIMENTS

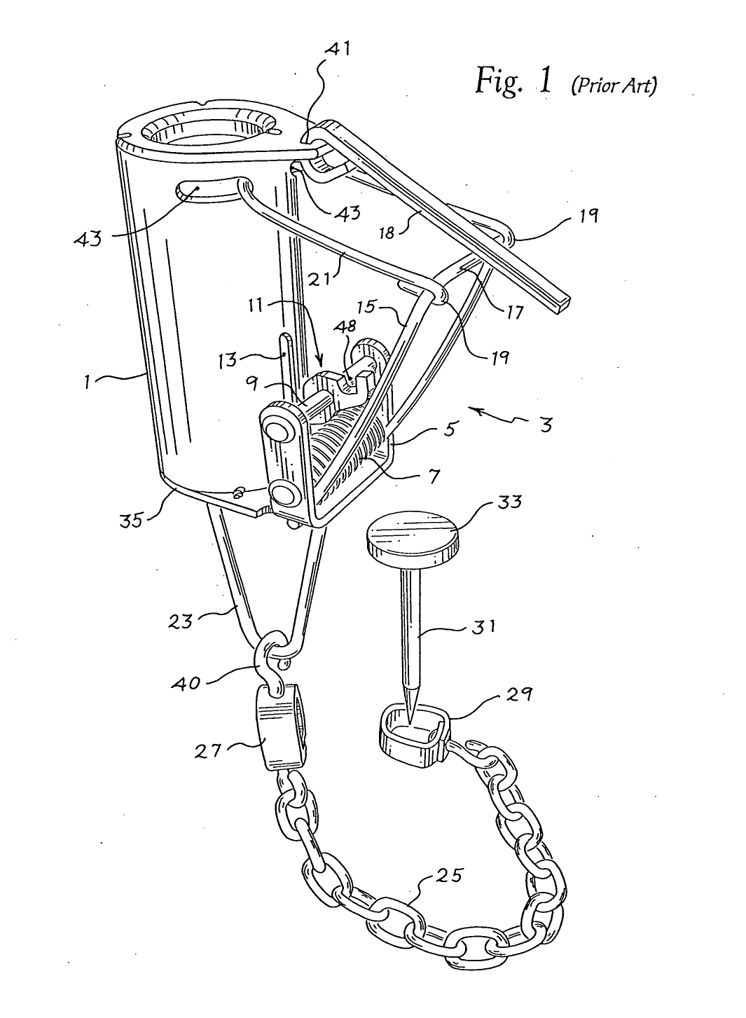

FIG. 1 illustrates a perspective view of a trap that is known commercially as the little Lil' Grizz Get'rz. This trap has been sold and widely used in the United States and other countries for about a decade. The improved bait trigger that will hereinafter be disclosed can be used with the Lil' Grizz Get'rz and other foot restraint traps for animals, including raccoons.

With reference to FIG. 1, the Lil' Grizz Get'rz trap is made from burnished steel to eliminate sharp edges that could otherwise cut a trapped animal. The trap has a cylindrical housing or body 1 that supports a spring assembly 3 that includes a spring bracket 5 which supports a spring 7 and a fixed trigger actuator shaft 9. A bait trigger 11 passes through a vertical actuator slot 13 that is formed in the cylindrical housing 1 and is supported for pivoting on the shaft 9 and associated up-and-down movement of a lever actuator portion of the bait trigger (not shown in FIG. 1) within the housing 1.

The spring 7 has extending spring arms 15 that are cross-connected at their top ends by an associated integral horizontal cross-bar 17. The cross bar 17 engages loops formed at the outer ends 19 of a U-shaped restraint clamp 21.

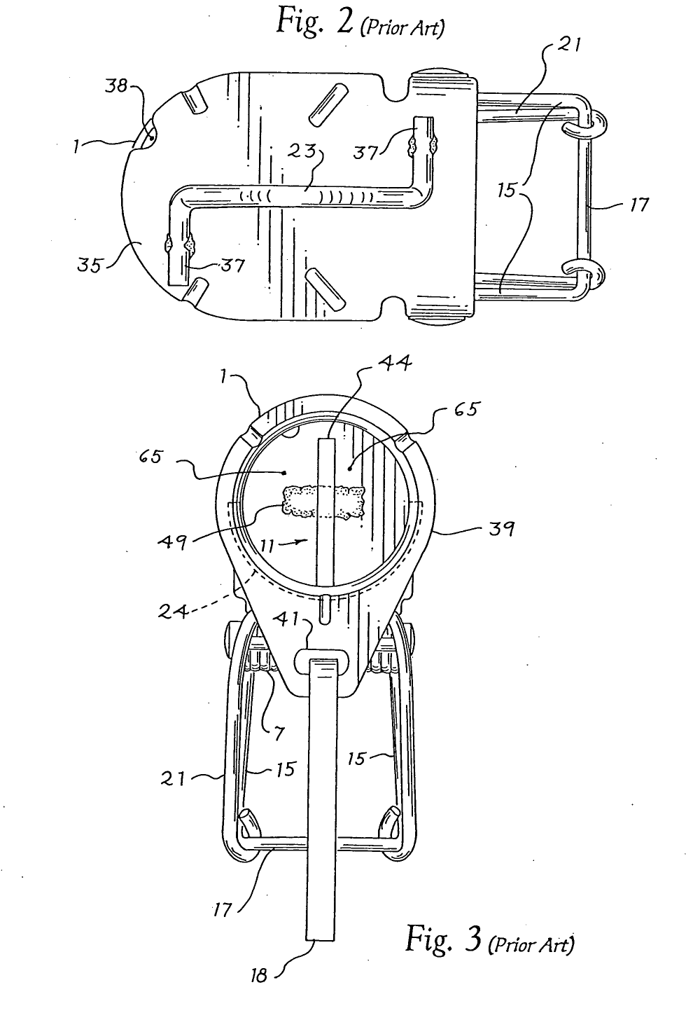

As shown in FIGS. 1 and 2, the cylindrical housing 1 has a bottom plate 35 that is affixed to a V-shaped anchor 23. As shown in FIG. 1, a restraint chain 25 has a double-swivel connector 27 that engages the V-shaped anchor 23 at one end and a single swivel connector 29 at the other end that is held in a fixed position on the ground by a shaft 31 of a stake 33. The chain and swivels are about 12 inches (30.48 cm) long. Thus, the chain 25 constrains movement of the trap and any animal restrained by the trap within a defined area.

FIG. 2 shows the bottom plate 35 of the cylindrical housing 1 with ends 37 of the V-shaped anchor 23 affixed to the base 35, for example by welding. The bottom plate 35 has a hole 38 that is used to drain water or other liquids that may collect within the cylinder housing 1. As shown in FIG. 1, the bottom end of the anchor 23 is rounded to receive a connector end 40 of the swivel connector 27 so that the chain 25 can twist with twisting movement of the housing 1 without kinking the chain.

FIG. 3 shows a top plate 39 that is affixed to the cylindrical housing 1, for example by welding. As shown in FIGS. 1 and 3, the top plate 39 has an opening 41 within which a trigger arm 18 is engaged as shown. With reference to FIGS. 1 and 3, the restraint clamp 21 passes through slots 43 of the cylindrical housing 1 so that the inner curved portion of the restraint clamp 21 is disposed at the edge of the inner surface of the cylindrical housing 1 at the periphery of the housing when the raccoon restraint trap of FIG. 1 is in the illustrated released or triggered position of FIGS. 1 and 3.

As shown in FIGS. 1 and 3, the bait trigger 11 of the trap has a lever actuator 44 that is disposed within the cylindrical housing 1. The lever actuator 44 triggers the trap when the trap is set by pressing the spring arms 15 of FIG. 1 toward the housing 1 and engaging the free end of the trigger arm 18 in a notch 48 at the outside end of the bait trigger 11.

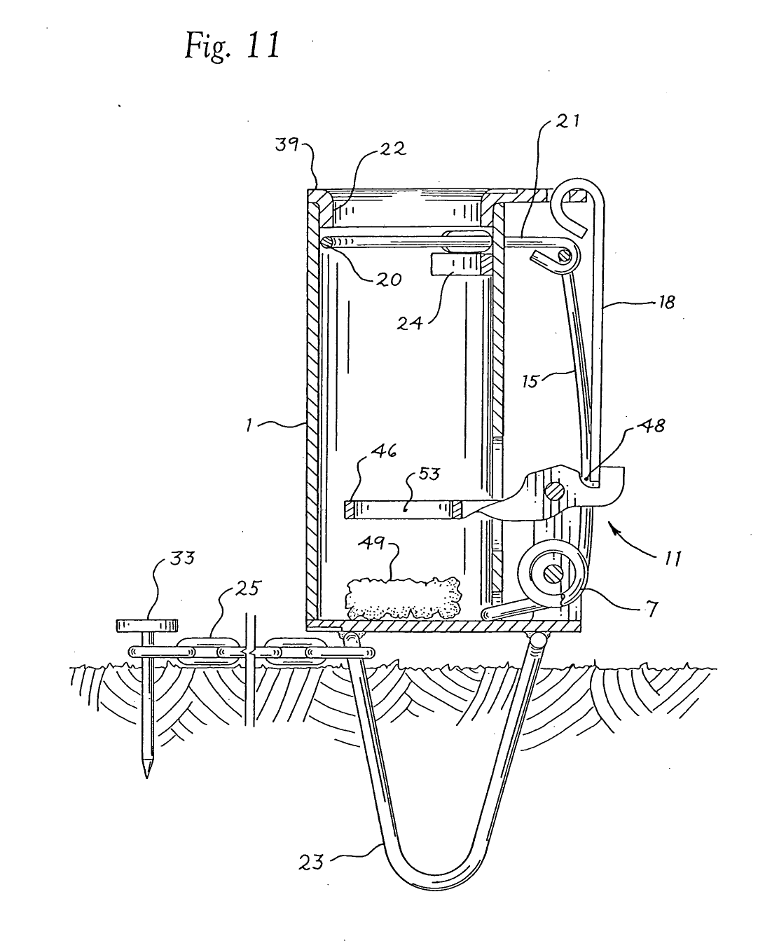

When the trap is set as shown, for example, in FIG. 11, the trigger arm 18 holds the horizontal cross bar 17 at its set position adjacent to the housing 1, with the restraint clamp 21 pressed into the housing 1 and its u-shaped end 20 hidden under an overhang 22 of the top plate 39 to allow a smooth and unobstructed entry of an animal's paw or paws into the top of the housing 1. In the set position of the trap, the raccoon doesn't see the u-shaped end 20 of the clamp 21 and it therefore won't play with or disturb it.

Pushing down on the lever actuator 44 of FIG. 3 will not trigger the trap. However, when the raccoon pulls up on the actuator 44 of the set trap, the trap is triggered and the spring 7 forces the restraint clamp 21 to hold the paw or paws of the raccoon within the housing, pressed against a c-shaped internal grip bar 24 disposed below the slots 43 and attached to the inside wall of the housing 1, for example by welding. The lateral pressing force of the clamp 21 causes the skin and hair of the raccoon to be creased against the grip bar 24 and orients the clamped paw or paws at an angle so that the raccoon can't pull its trapped paw or paws directly from the trap.

Operation of the trap will hereinafter be discussed with reference to a single foot or paw being inserted and restrained within the trap. Although this is the usual operation, it should be understood that occasionally an animal such as a raccoon will put two front paws into a trap and if the trap is triggered, the two paws will be restrained within the trap. So any reference to a single foot or paw herein should be understood to encompass and include an operation where one or more feet/paws are trapped.

In the Lil' Grizz Get'rz trap, the cylindrical housing 1 is about 3.75 inches (9.525 cm) high and the anchor 23 is about 2.75 inches (6.985 cm) high. The cylindrical housing 1 is 1.375 inches (3.493 cm) in diameter and the actuator lever 44 of FIG. 3 is centered in the housing 1 and is about 0.125 inch (0.318 cm) wide. The actuator lever has a space 65 on either side which is about 0.625 inch (1.588 cm) wide. With these dimensions, the cylindrical housing 1 can receive and pass the front paw of a raccoon, but will be too small to receive and pass a paw of most dogs. If a sufficiently small dog or other such animal does press its paw into the cylinder, the downward pressure of the paw on the actuator lever 44 will not trigger the trap. Only a dexterous animal such as a raccoon will be able to pull up on the actuator lever 44 and activate the trap.

In operation over many years it has been found that raccoons will often reach within the housing 1 of the Lil' Grizz Get'rz trap of FIG. 3 and will inadvertently pull the lever 44 upward while attempting to grasp and pull out bait 49. The trap will then be activated and the raccoon's foot will be humanely restrained within the housing 1. However, even though the operational reliability of the Lil' Grizz Get'rz has been demonstrated over many years, there are instances when raccoons have been able to defeat the operation of this trap.

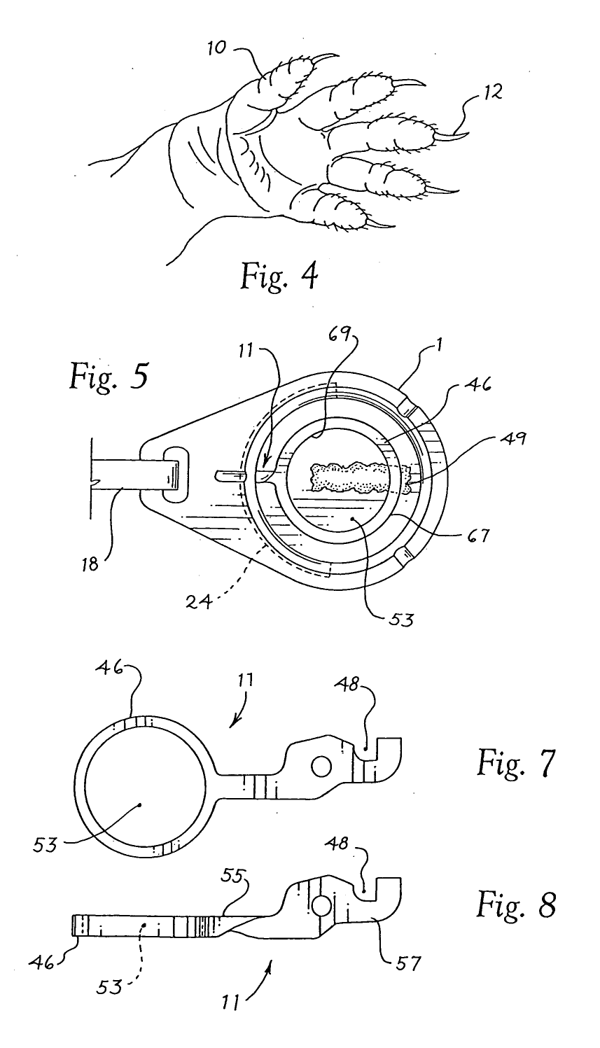

The dexterity of raccoons should not be underestimated. FIG. 4 illustrates the underside of the front paw of a typical raccoon. As shown, the paw has a rough under pad 10 that may become pliable when wet and five separate finger-like toes with claws 12. The toes are very sensitive to tactile stimuli and can manipulate small objects, even absent an opposable thumb.

The toes of a raccoon have stiff hairs that are in essence whiskers with considerable touch-sensitivity. So the raccoon can “feel” objects with its front toes and can easily discriminate a cold, hard metal surface from the soft, yielding surface of food. The front paws of a raccoon may be about 2 inches (5.08 cm) long and roughly 1.25 inches (3.175 cm) wide.

Raccoons can squeeze their paws into very small areas and are adept at probing ground holes for food, which is why the Lil' Grizz Get'rz trap works best oriented vertically, so a raccoon can reach down into the opening of the trap in a manner similar to what would be done in reaching for food within natural ground holes. The raccoon's rear paws are larger than the front paws and are less suitable for manipulation of objects, so only the front paws are typically used to grasp food.

With reference to FIG. 3, it has been found that raccoons will reach around the actuator lever 44 when seeking to touch underlying bait. This is not surprising as the raccoon's toes will initially sense the hardness of the lever as the toes move downward into the housing 1 and the toes will then move to the side area 65 of the lever and will make contact with the yielding surface of the bait 49 which will be recognized as food. The raccoon may then tease the bait 49 from the trap without pulling up on the lever 44.

A dexterous raccoon can therefore remove bait from a lever-actuated trap without triggering the trap. Studies have shown that raccoons can recall learned experiences for several years. Accordingly, once a raccoon learns how to retrieve bait from a trap, it can be expected to continue to successfully remove bait from such traps, perhaps for years. It has been suggested that a cross-piece could be added to the actuator lever of foot restraint traps in order to prevent raccoons from stealing bait. However, this suggestion was rejected as not effective for all trapping situations.

In considering this trapping reliability issue with use of the well-known lever actuator, it was realized a lever is not the most reliable shape for causing a dexterous raccoon to activate a foot restraint trap. In general, an improved actuator should overlie or capture the bait and should extend over a considerable portion of the cross-sectional area of the housing. The improved actuator should cooperate with the housing so that the actuator can pivot as required, but not allow the paw of a raccoon to bypass the actuator and directly access underlying or captured bait.

In addition, if possible, the actuator should be shaped so that it will snag the pad and/or claws of the raccoon's paw as the paw grasps or touches the bait so the actuator will be lifted upward as the paw moves upward with or without the bait. And, if possible, the actuator should be shaped so that the toes of the raccoon will pass through an open area of the actuator so the raccoon will touch and feel the underlying bait without undue obstruction by the actuator, but the paw will pull up on the actuator with the bait.

FIG. 5 shows an illustration of a preferred ring-shaped actuator end portion 46 of the bait trigger 11 with the above-noted favorable operational features. As shown in FIG. 5, the ring actuator is disposed within the cylindrical housing 1 for pivoting as previously discussed and its outer periphery cooperates with the inner wall of the housing to block a raccoon's paw from bypassing the actuator and directly accessing the bait 49.

For example, the outer peripheral edge of the ring portion of the actuator may be spaced about 0.25 inch (0.635 cm) from the inner wall of the cylinder 1 and this air gap is sufficiently close so that a raccoon's paw cannot pass the actuator, yet it allows the actuator to freely pivot within the cylindrical housing. The actuator is about 0.0625 inch (0.1588 cm) thick, has a 1.0625 inch (2.699 cm) outside diameter, a 0.875 inch (2.223 cm) inside diameter, and is made of burnished steel.

The ring shape of the actuator of FIG. 5 is preferred because it blocks direct access to the bait and also will engage a raccoon's paw. In operation, the outer edge 67 of the ring actuator 46 will typically snag one or more claws 12 of the paw and the inner edge 69 will snag the rough pad 10 of the paw, thereby causing the actuator to move with the paw and trigger the trap when the paw moves upward.

Also, a central opening 53 of the ring actuator is defined by the inner edge 69 of the ring. This opening allows the raccoon's toes to pass downward from the plane of the actuator to touch underlying bait. The tactile sensation of food will motivate the raccoon to continue to manipulate the actuator and will eventually result in activating the trap. Also, if bait is pressed into the inner opening 53 it will be captured by the actuator and will therefore be well-presented to the raccoon to maximize positive tactile feedback and will again encourage the raccoon to continue to manipulate the ring actuator until the trap is activated.

The advantageous clearance of the ring actuator with the inner wall of the cylindrical housing and the other noted favorable features of the ring actuator provide significantly improved trapping performance which ensures that a raccoon will not remove bait from the trap and, if the raccoon manipulates the actuator long enough, it will be trapped.

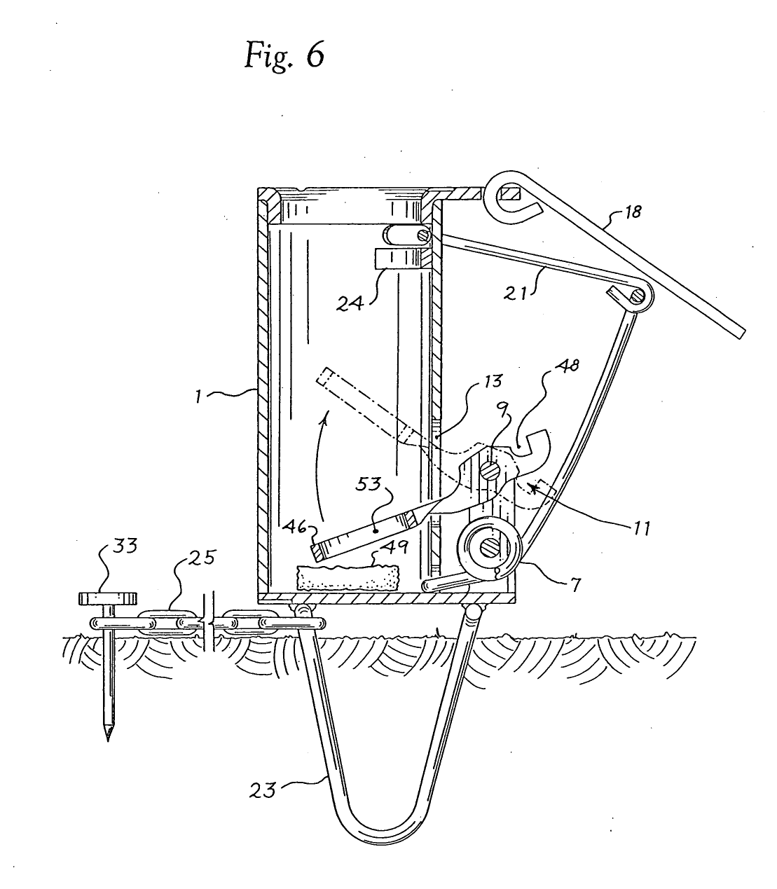

FIG. 6 illustrates a cross-sectional view of the improved trap of FIGS. 1-3 with the preferred ring-shaped bait trigger 11 shown extending from outside the housing 1, through the slot 13 and positioned with the actuator end 46 at its furthest downward-facing orientation within the housing 1.

As previously noted, the bait trigger 11 pivots about the actuator shaft 9. As shown in FIG. 6, the bait trigger may be pivoted to an upward position shown by phantom lines. And as previously noted, when the trap is set, the trigger arm 18 engages a slot 48 formed at the outside end of the bait trigger 11. In this “trap set” position as shown in FIG. 11, the bait trigger 11 is held at a position roughly midway between the outer positions shown in FIG. 6, and also as previously noted, the spring 7 is held by the trigger arm 18 in tension to bias the restraint clamp 21 toward clamping movement.

A piece of bait 49 is shown disposed on the floor of the cylindrical housing 1 of FIG. 6, underneath the actuator 46 when the cylindrical housing 1 is disposed in a vertically upright position. For example, the bait may be a marshmallow, a piece of fish such as herring, a fish-oil soaked piece of bread or a piece of dough made from food of interest to a raccoon.

The anchor 23 of FIG. 6 is engaged in the ground, for example by pressing the anchor into the ground and then twisting the assembly of the cylindrical housing 1 so that the anchor is firmly embedded in the ground with the cylindrical housing 1 disposed in an upright position. As noted previously, this is the preferred position at which the trap is used to lure and restrain a raccoon.

In this upright position, the anchor 23 prevents the cylindrical housing 1 from being pushed over, for example by curious dogs or other animals. Also as shown, in this ground-engaging position, the restraint chain 25 and associated embedded stake 33 prevent the trap from being moved away from a circular area defined with the stake 33 at its center. For simplicity of illustration, the chain of FIG. 6 is not shown with end swivels.

It should be understood that a chain with swivels as described is the preferred apparatus for restraining movement of the trap when the trap is triggered. However, other tethers could also be used, for example metal cables or cables made from other wear resistant materials.

It should be understood that the trap of FIG. 6 may also be held in place by affixing the outer end of the restraint chain 25 to any suitable fixed object, for example a tree or a heavy boulder or rock. And the chain or other suitable tether may be used without end swivels, although swivels are preferred to avoid kinking the chain and associated harm to a restrained animal.

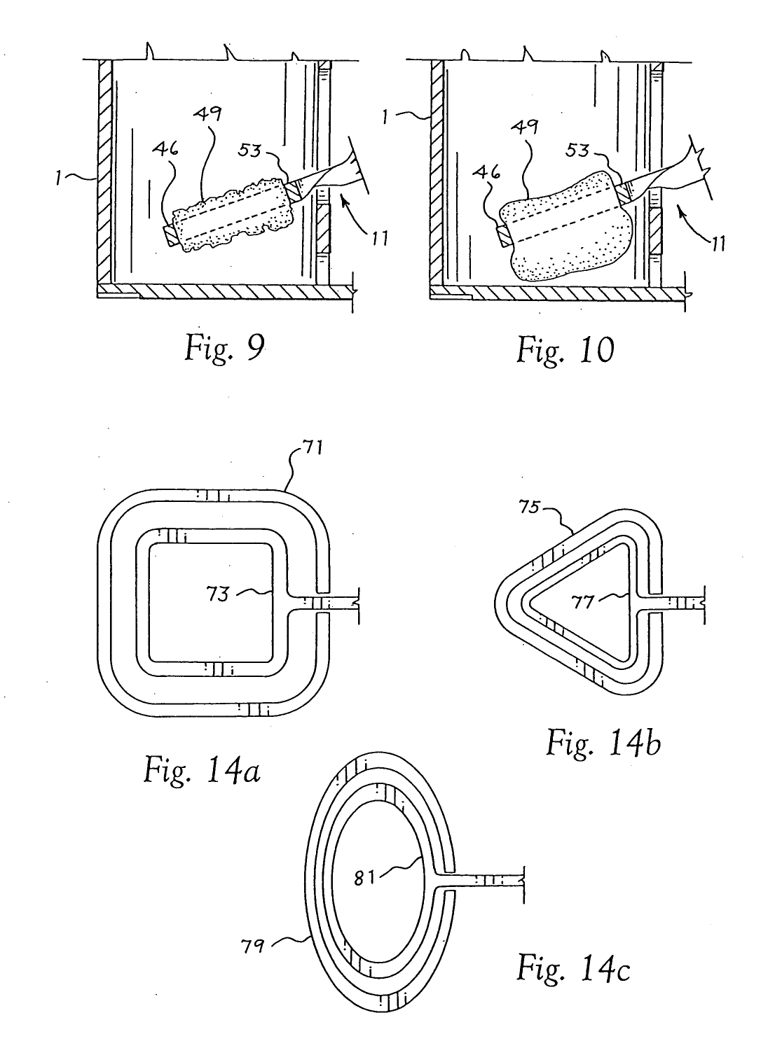

FIG. 7 illustrates a preferred bait trigger 11, with the aforementioned ring-shaped actuator end 46 in the form in which it is initially manufactured from a suitable metal, for example burnished steel. FIG. 8 illustrates the bait trigger 11 with a twist 55 that is made in manufacturing, for example by means of a jig, so that the ring-shaped actuator 46 of the bait trigger 11 is oriented at right angles to a face 57 of the outer lever portion of the bait trigger 11.

In manufacturing the restraint trap of FIG. 6, the ring actuator 46 of the bait trigger 11 is inserted vertically through the vertical actuator slot 13 of the housing 1 and is then rotated so the upper face of the ring actuator 46 faces upward toward the opening at the top of the housing 1. As previously noted, a lever portion of the bait trigger 11 extends outside of the housing 1 and is pivoted on the trigger actuator shaft 9, as shown at FIG. 6.

FIG. 9 illustrates a bottom portion of the cylindrical housing 1, showing bait 49 embedded with and captured by the central opening 53 of the actuator end 46 of the bait trigger 11. FIG. 10 illustrates a corresponding bottom portion of the cylindrical housing 1 with the actuator 46 of the bait trigger 11 disposed to rest on and capture the top portion of a relatively large portion of bait 49, for example a marshmallow. Any one of the noted bait configurations of FIGS. 6, 9 and 10 may be used with the improved trap of FIG. 6.

It should be appreciated that the ring-shaped actuator can be quickly and easily baited. This is very important to trappers who may have to bait and set many such traps in inclement weather.

In operation, the trapper presses the outer end of the bait trigger 11 down so that the actuator end 46 flips up toward the top of the cylindrical housing 1. The trapper may then drop bait within the housing so that it falls to the base of the housing 1.

Alternatively, the trapper presses bait into the central opening 53 of the actuator 46 so that it is captured by the actuator and then releases the outer end of the bait trigger so that the ring actuator drops down into the housing. The trap is then set as usual by hand or with any tool that may be required to assist in setting the trap and the anchor of the trap is pressed into the ground to hold the trap upright at any desired trapping location. The far end of the restraint chain is then fixed.

FIG. 11 shows the improved trap in its vertically upright position with the anchor 23 embedded in the ground. The restraining chain 25 for the trap is shown without swivels for simplicity of illustration. As shown in FIG. 11, the trap is set with the spring arms 15 disposed vertically and the trigger arm 18 engaged in the slot 48 of the bait trigger arm 11 as previously discussed. In the set trap of FIG. 11, the U-shaped clamping arm 21 is fully pushed into the housing 1 so that it presents an open area for receiving, for example the front foot of a raccoon.

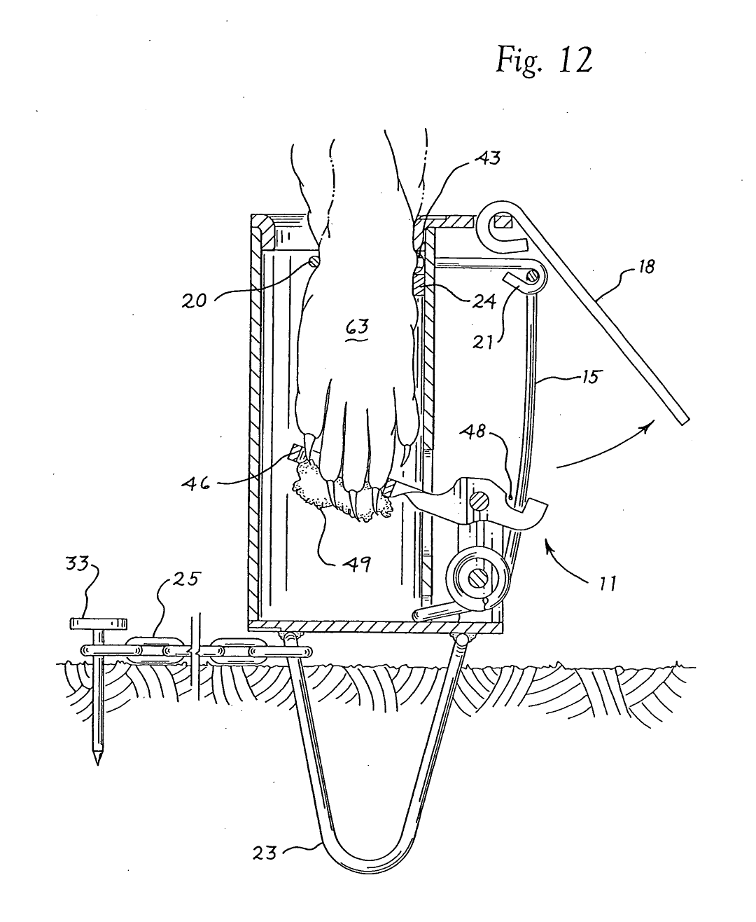

FIG. 12 illustrates the trap of FIG. 11, wherein the paw 63 of the raccoon has engaged and snagged the actuator 46. The raccoon will eventually pull its paw upward in attempting to retrieve the bait and this upward pulling movement will pivot the actuator 46 of the bait trigger 11 upward and will activate the trap. The trigger arm 18 will therefore be disengaged from the notch 48 and the double spring arms 15 will pull the restraint clamp 21 closed so that it clamps and restrains the upper area of the raccoon's foot against the internal grip bar 24.

Although the double force of the spring 7 is considerable, for example at least 50 pounds, the raccoon's trapped foot will not be injured, because the clamp 21 does not move a sufficient distance against the raccoon to injure the skin or bone of the trapped foot.

When the raccoon's foot is clamped, the raccoon will attempt to extract its foot from the trap. For example, a raccoon will typically lift up its trapped foot and will extract the anchor 23 of the trap from the ground. This is expected as a normal occurrence of the trapping process.

When the trap is freed from the ground, a raccoon will typically pull at its foot and twist its body in an effort to escape the trap. With reference to FIG. 1, when the trap is pulled from the ground, the end loop 40 of the swivel 27 of the chain 25 will typically slide down the leg of the anchor 23 and will rest at the curved lower end of the V-shaped anchor 23 so that any pulling force from the raccoon will be applied along the line of the chain, and this will not injure the raccoon.

Typically, a raccoon will extend its trapped leg and will twist and roll on the ground in an effort to escape the trap. When this is done, the double swivel 27 of the chain twists with the raccoon and prevents the chain 25 from kinking. Also, a swivel 29 at the opposite end of the chain twists with respect to the stationary ground stake 33 or other thing that holds that end of the chain in a fixed position. The swivels of the chain ensure that the raccoon can twist and move erratically, without kinking the chain and injuring itself, for example by attempting to continually twist and move against an unyielding kinked chain, thereby breaking bones or causing other damage. Use of the noted swivels ensures that the trapped raccoon is restrained in a humane manner without undue pain or suffering.

Also, since the raccoon's foot is trapped in a metal housing, the raccoon cannot bite or gnaw at the area of restraint and thereby injure itself, for example by gnawing off its foot. The raccoon is therefore held by the chain in a restricted area and is allowed to move without causing undue harm or pain.

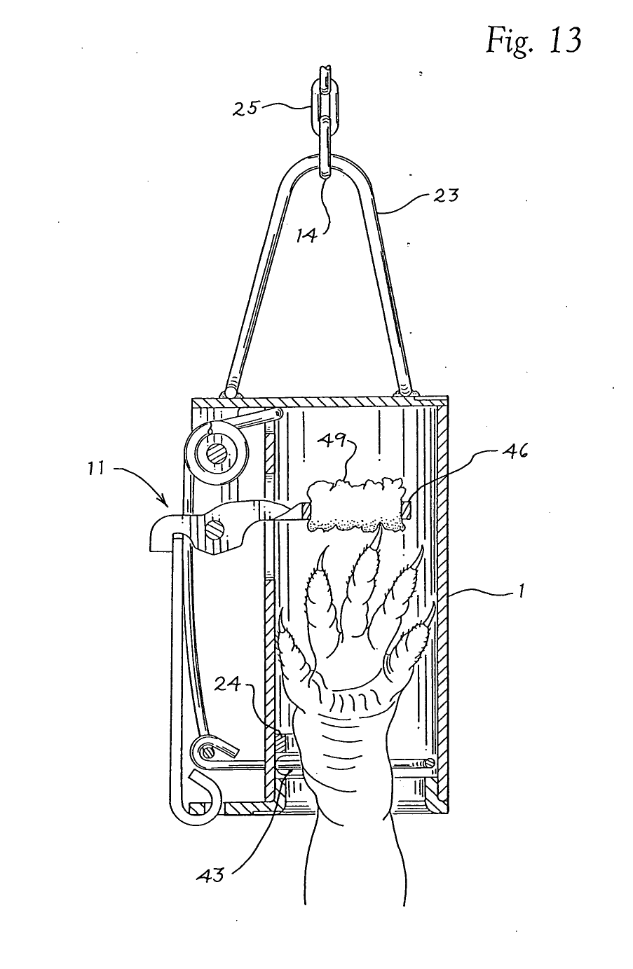

FIG. 13 shows the trap of FIGS. 6, 11 and 12 hung in an upside-down orientation, for example by the anchor 23 and the chain 25, which may be supported by a nail or hook (not shown) engaged by the chain at a position 14 or at any other desired position. In this reversed orientation, the bait 49 is supported by the actuator end 46 of the bait trigger 11. Any paw of a raccoon that enters through the opening of the housing 1 will engage and activate the actuator 46 as previously described when the raccoon attempts to retrieve the bait 49. The chain 25 of FIG. 13 is shown without swivels for simplicity of illustration.

The trap is therefore capable of operating in either an upright or upside-down position. Of course, if the trap is hung upside-down, it must be hung in a manner that will allow the trap to restrain a foot of the raccoon without also hanging the raccoon. Typically, the trap is hung upside down within a culvert, about 16 inches (40.64 cm) above the bottom of the culvert, in order to suspend the trap above water or debris. Raccoons can reach up from the bottom of the culvert and trigger the trap. The raccoon will then pull the trap and chain down from the supporting nail or hook while struggling to escape, so the trap is typically secured as usual with the chain 25 staked or otherwise held at its far end.

It should now be appreciated that the V-shaped anchor 23 is well-suited for achieving several distinct functions. Thus, the anchor is easily engaged in the ground sufficiently firmly that the trap is held upright despite pushes that it may receive from inquisitive animals. And yet the anchor engages the ground sufficiently loosely that a trapped raccoon may lift it from the ground and thereby achieve a more comfortable position while restrained.

And the anchor operates with swivels to prevent the raccoon from injuring itself when it struggles with the trap. Also, if the ground freezes after the trap is placed; the anchor 23 can be relatively easily disengaged from the ground in order to achieve its humane trapping functions and also allow the trapper to easily retrieve or reset the trap in cold weather conditions. And, as noted above, the anchor can be used to hang the trap for operation upside down.

Although the disclosed versatile anchor 23 is preferred for use with a foot restraint trap for all the noted reasons, other types of anchors could be used. For example, a straight stake-like positioning anchor could be used, although it should be appreciated that a straight anchor might cause undesirable kinking of the restraint chain and might not be easily disengaged, for example from frozen ground; thus possibly inhibiting humane restraint functions and causing injury to a trapped animal. And a straight anchor may not be readily adapted for hanging a trap upside down. So types of anchors other than the disclosed V-shaped anchor 23 may result in operational compromises.

Although the ring actuator of FIGS. 5-8 is preferred, particularly for use with a cylindrical trap, other shapes of traps and associated actuators could be used to achieve the noted advantageous trapping result. For example, FIG. 14a illustrates a diagrammatic illustration of a foot restraint trap with a square cross-section 71 and an associated square actuator 73 that should have similar advantageous trapping results as has been found for the ring actuator of FIGS. 5-8 in combination with a cylindrical housing.

Likewise, with respect to FIG. 14b, a trap with a triangular housing 75 could operate favorably with an associated triangular actuator 77. And with reference to FIG. 14c, a trap with an elliptical cross-section 79 could operate advantageously with an associated elliptical trigger 81.

It should generally be appreciated that different shapes of actuators could also be used effectively with different cross-sectional shapes for associated housings of a trap. Thus, for example, a hexagon or octagon-shaped actuator (not shown) could be used with different cross-sectional shapes of traps and also square, rectangular, triangular and elliptical actuator shapes could operate favorably with cylindrical housings or housings of any shape, so long as the actuator spacing from the inside wall of the housing is large enough to allow pivotal movement of the actuator and is small enough to block peripheral passing movement of a raccoon's paw.

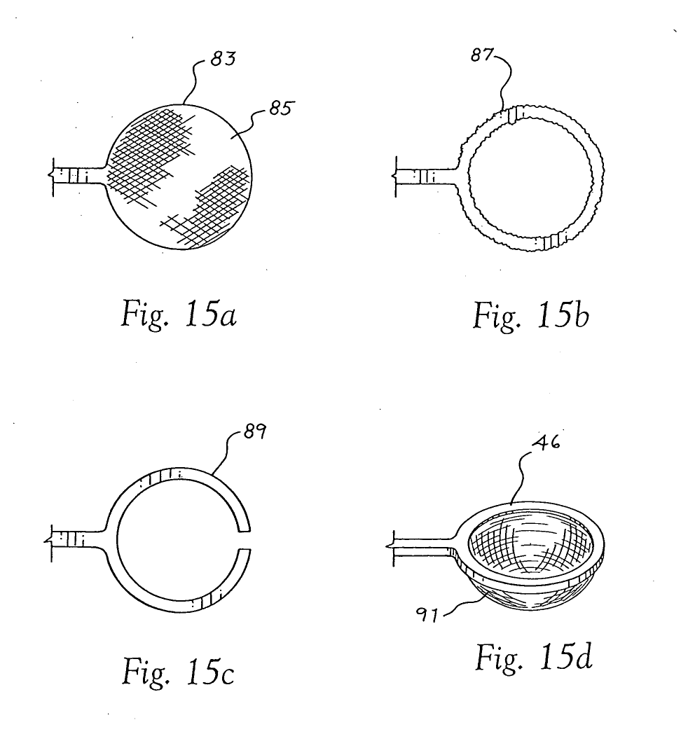

Although a preferred ring-shape for the actuator of a bait trigger has been disclosed, it should be understood that different ring-actuator shapes could also achieve favorable results with a trap having a cylindrical or any shape housing. For example, with reference to FIG. 15a, a solid disk 83 could be used as an actuator. The outer peripheral edge of this disk would snag the claws of a raccoon as previously discussed. Also, the inner solid surface of the disk could be knurled at 85 to provide a rough surface for snagging the pad of a raccoon's foot.

With reference to FIG. 15b, the inner and outer peripheral surfaces of a ring actuator could be serrated at 87 to facilitate snagging the paw and claws of a raccoon.

With reference to FIG. 15c, a partial ring actuator 89 could also be used to engage a raccoon's foot as previously described.

And with reference to FIG. 15d, a ring actuator 46 as previously described could include a net 91, made for example of metal mesh, to retain bait. This actuator would also snag the paw and claws of a raccoon seeking to retrieve the bait.

The disclosed improved actuator is well suited for use with any foot restraint traps, including the Lil' Grizz Get'rz. However, this actuator has other potential uses. It could be used as a trigger mechanism for any device that is particularly directed to operation by a raccoon. For example, the actuator could be used to trigger closing the door of a box trap or for any other raccoon-initiated function.

In operation of a box trap, the actuator would be supported in an actuator housing as previously described and bait would be used in the same way, without requiring use of a foot clamping mechanism or an anchor. The actuator assembly would be placed within the box trap and when a raccoon enters the box, reaches into the actuator housing and pulls up on the actuator, that movement would activate a mechanism that closes the door of the box trap.

Other functions could also be achieved by the improved actuator without requiring a foot restraint or like mechanism. It is even possible that the actuator could be used without bait, as it has been found that raccoons will occasionally trigger the actuator in the act of playing with it, without requiring bait to entice this activity.

It should now be understood that the disclosed invention encompasses different materials and configurations of parts that could achieve the noted advantageous features of the invention. It is therefore intended that the foregoing detailed description be regarded as illustrative rather than limiting, and that it be understood the following claims, including all equivalents, are intended to encompass the full scope of the invention.

1. A humane trap for selectively engaging and holding one or more feet of an animal having paws and claws, the trap comprising:
a housing with an opening for receiving at least one foot of said animal and with at least one inside wall defining an enclosed space;
bait for attracting said animal and enticing it to stick at least one foot into said housing in an attempt to remove the bait;
a bait trigger disposed over said bait and supported for movement between a stable set position and a triggered latched position with respect to said housing;
said bait trigger having an actuator disposed within said housing between said bait and the animal attempting to access the bait, said actuator having a body with a peripheral outer edge that is sufficiently close to said at least one inside wall of the housing to prevent the animal from accessing the bait without also touching the actuator, the actuator having means for snagging the animal's at least one foot so the foot moves the bait trigger in a predetermined direction when the animal attempts to retrieve the bait;
a spring assembly connected to said bait trigger for biasing said bait trigger for movement from said set position to said triggered latched position when the bait trigger is moved in said predefined direction;
a foot clamp for opening and allowing said at least one foot to move into said housing when the spring assembly is in said set position and for closing and clamping said at least one foot and holding it within said housing when the at least one foot engages said actuator and moves said bait trigger in said predefined direction; and
a tether disposed for confining movement of said housing within a predefined area so said animal cannot escape from said area when it's at least one foot is held within said housing.

2. The humane trap of claim 1, further including a positioning anchor affixed to said housing for engaging the ground and holding the housing in an upright position while the spring assembly is maintained in said stable set position; and for being disengaged with the ground by a struggling animal with at least one foot trapped within the housing.

3. The humane trap of claim 2, wherein said tether includes a chain with a stake at one end that holds said one end of the chain to the ground and one or more swivel connections that connect the chain at its other end to the positioning anchor to allow a trapped animal to move without kinking the chain and injuring itself.

4. The humane trap of claim 1, wherein said actuator is a ring with an inner edge for snagging at least one of said paws of the animal and an outer edge for snagging at least one claw of the animal.

5. The humane trap of claim 1, wherein said actuator is defined by a peripheral edge of any shape for snagging at least one of said claws.

6. The humane trap of claim 1, wherein said bait trigger includes a lever integral with said actuator and twisted so that the actuator and lever are disposed at a right angle to each other, and said housing includes a slot dimensioned to pass said actuator edgewise into the interior of said housing and thereby facilitate assembly of the actuator within the housing.

7. The humane trap of claim 1, wherein said foot clamp includes a spring biased moveable clamping bar with a curved surface and an associated opposite stationary grip bar with a curved surface for engaging said at least one foot of the animal on opposite sides of the foot and humanely restraining the foot within said housing.

8. A humane animal trap, comprising:
bait for attracting an animal;
a housing with an opening for receiving at least one foot of said animal having a paw and claws;
a bait trigger supported for movement with respect to the housing and having an actuator within the housing, the actuator disposed between the at least one foot of the animal entering the housing and said bait and dimensioned so that at least one paw or at least one claw of said at least one foot will snag the actuator when the animal attempts to retrieve the bait;
a mechanism having means for restraining the animal's at least one foot within said housing when the snagged actuator is moved by the animal; and
a tether for holding the trap within a predefined area.

9. The humane animal trap of claim 8, wherein said trap restrains an animal with the opening of the housing pointing upwards or downwards.

10. The humane animal trap of claim 8, wherein said tether is a chain connected to said trap at one end and fixed against movement at the other end.

11. The humane animal trap of claim 8, further including a positioning anchor for holding the trap in an upright position before the trap is triggered and for allowing the trap to be pulled from the ground by a trapped animal when the trap is triggered.

12. The humane animal trap of claim 11, wherein said tether is a chain that includes swivels at its ends connected to said anchor and affixed to the ground to prevent kinking of said chain as a restrained animal twists and struggles, so that the animal will not be injured.

13. The humane animal trap of claim 8, wherein said actuator is ring-shaped and formed integral with an associated activating lever and the ring-shaped actuator is twisted with respect to the lever so it is oriented at right angles to the lever, and said housing has a slot dimensioned to pass the ring-shaped actuator edgewise into the interior of the housing to facilitate assembly of the actuator within the housing.

14. The humane animal trap of claim 8, wherein said mechanism includes a spring biased moveable clamping bar with a curved surface and an associated opposite stationary grip bar with a curved surface for engaging at least one foot of the raccoon on opposite sides of the foot and humanely restraining the foot within said housing.

15. A humane animal trap, comprising:
a housing with an opening for receiving at least one foot of an animal and defining an interior surface within the housing;
bait within the housing;
a bait trigger supported for movement with respect to said housing and having an actuator within the housing, said actuator disposed over said bait so that the actuator covers the bait and cooperates with said interior surface to obstruct independent access to the bait by the at least one foot of the animal;
a mechanism for restraining the at least one foot of the animal within the housing and preventing extraction of the at least one foot when the animal reaches into the housing and attempts to retrieve the bait by pulling on the bait trigger; and
a tether for confining movement of the housing within a predefined area and thereby trapping a restrained animal within that area.

16. The animal trap of claim 15, wherein the actuator is shaped to snag at least one foot of the animal and thereby facilitate actuation of the foot restraining operation of said mechanism.

17. The animal trap of claim 15, wherein said actuator is ring-shaped.

18. The animal trap of claim 15, wherein the housing is cylindrical and the actuator is ring-shaped.

19. The animal trap of claim 15, wherein the animal's at least one foot has a paw and claws and said actuator has an outer peripheral edge for snagging at least one claw and an inner edge for snagging said paw when the animal attempts to retrieve said bait.

20. The animal trap of claim 15, further including a v-shaped positioning anchor for engaging the ground and holding said housing in a vertical orientation to receive at least one foot of the animal, and for allowing the positioning anchor and housing to be extracted from the ground by a restrained animal to facilitate movement of the animal and thereby avoid unnecessary injury.

21. The animal trap of claim 20, wherein said tether is a chain with a double swivel at one end connected to said positioning anchor and a single swivel at the opposite end with means for affixing that end to a fixed location, so that the chain will twist with twisting movement of a restrained animal and will not kink and thereby injure the animal.

22. The animal trap of claim 15, wherein the opening of the housing is sized to block the feet of most dogs from entering the housing and wherein the foot restraint of the trap is achieved by a movement of said bait trigger that cannot be accomplished by a dog or other animal having less dexterity than a raccoon.

23. The animal trap of claim 15, wherein said mechanism includes a spring biased moveable clamping bar with a curved surface and an associated opposite stationary grip bar with a curved surface for engaging at least one foot of the animal on opposite sides of the foot and humanely restraining the foot within said housing.

24. A raccoon trap, comprising:
a housing with an opening for receiving at least one foot of a raccoon and defining an interior surface within the housing;
a ring-shaped trigger actuator disposed within the housing and cooperating with the interior surface of the housing for reliably engaging said at least one foot of said raccoon and preventing the foot from bypassing the trigger actuator;
a mechanism for trapping said at least one foot of said raccoon within the housing when said at least one foot pulls the ring-shaped actuator toward said opening; and
a tether for confining the housing and the trapped raccoon within a predefined area.

25. The raccoon trap of claim 24, wherein said mechanism includes a spring biased moveable clamping bar with a curved surface and an associated opposite stationary grip bar with a curved surface for engaging at least one foot of the raccoon on opposite sides of the foot and humanely restraining the foot within said housing.

26. A raccoon-actuated device, comprising:
a housing with an opening for receiving a paw of a raccoon and defining an interior peripheral wall within the housing;
a trigger actuator disposed within the housing and surrounded by said interior peripheral wall, the actuator having a peripheral edge that is spaced a sufficiently close distance from the interior peripheral wall so that the paw of the raccoon will reliably engage the actuator when the paw is moved through the opening and into the housing and so that the paw cannot move past the peripheral edge of the actuator and directly access a space beneath the actuator; and
a mechanism for achieving a predefined function when the raccoon pulls up on said trigger actuator.

27. The raccoon-actuated device of claim 26, wherein said trigger actuator has means for engaging and snagging the paw of the raccoon when the paw enters the housing and contacts the actuator.

28. The raccoon-actuated device of claim 26, wherein said trigger actuator is ring-shaped.
